(19) United States
(12) Patent Application Publication
(10) Pub. No.: US 2013/0183961 A1
(43) Pub. Date: Jul. 18, 2013

(54) AUTOMATIC NETWORK DESIGN

(71) Applicants: Masoud Bassiri, Singapore (SG); Hua Zhang, Singapore (SG); Duncan Karl Gordon Campbell, Singapore (SG); Tooraj Forughian, Singapore (SG); Neil Daniel, Singapore (SG)

(72) Inventors: Masoud Bassiri, Singapore (SG); Hua Zhang, Singapore (SG); Duncan Karl Gordon Campbell, Singapore (SG); Tooraj Forughian, Singapore (SG); Neil Daniel, Singapore (SG)

(73) Assignee: CONSISTEL PTE LTD., Singapore (SG)

(21) Appl. No.: 13/824,267

(22) PCT Filed: Sep. 16, 2011
(86) PCT No.: PCT/SG2011/000320

§ 371 Date: Mar. 15, 2013

Related U.S. Application Data
(60) Provisional application No. 61/383,746, filed on Sep. 17, 2010.

(51) Int. Cl. H04W 16/18

(52) U.S. Cl. CPC H04W 16/18
USPC 455/423; 455/446

(57) ABSTRACT

A method and system for communication network design, the method including: generating, by a computer processor, a plurality of receiver points; generating a target received signal strength for each receiver point of the plurality of receiver points; determining a predicted number of antennas based on a size of the communications network and a coverage area of an antenna; determining a location for each antenna of the predicted number of antennas; generating an estimated received signal strength for each receiver point of the plurality of receiver points, based upon the predicted number of antennas and the location of each antenna of the predicted number of antennas; comparing the estimated received signal strength for each receiver point with the target received signal strength for the receiver point; generating a revised predicted number of antennas based upon at least one of the comparisons of target received signal strength and estimated received signal strength.

### FIELD OF THE INVENTION

The present invention generally relates to automatic network design. In particular, although not exclusively, the invention relates to a method for automatic determination of antenna numbers and locations.

### BACKGROUND OF INVENTION

Intensive research interests have been in larger capacity and less transmission power of wireless handsets over wireless network design. One way to meet these requirements is to shrink the cell sizes and increase the number of cells. One important issue is the location and number of antennas.

Several patents relating to antenna placement are listed below:
[1]. Patent No WO0225506A1 entitled “Method and system for automated selection of optimal communication network equipment model, position and configuration in 3-D” by Rappaport Theodore, Skidmore Roger and Sheethalnath Praveen, 2002.
[2]. Patent No WO0227564A1 entitled “System and method for design, tracing, measurement, prediction and optimization of data communications networks” filed by Rappaport Theodore, Skidmore Roger and Henty Benjamin, 2002.
[3]. Patent No WO0178327A2 entitled “Method for configuring a wireless network” filed by Hills Alexander, H, 2001.
[4]. Patent No WO2008056850A2 entitled “Environment analysis system and method for indoor wireless location” filed by Cho Seong Yun, Choi Wan Sik, Kim Byung Doo, Cho Young-Su, Park Jong-Hyun, 2008.
[5]. Patent No WO2005027393A2 entitled “Simulation driven wireless LAN planning” by Thomson Allan and Srinivas Sudir, 2005.
[6]. Patent No WO0178326 entitled “Method for configuring and assigning channels for a wireless network” by Hills Alexander, H. and Schlegel Jon, P., 2001.
[7]. Patent No WO0178327 entitled “Method for configuring a wireless network” by Hills, Alexander, H., 2001.
[8]. Patent No WO0074401A1 entitled “Method and system for analysis, design and optimization of communication networks” by Rappaport Theodore and Skidmore Roger, 2004.
[9]. Patent No WO9740547A1 entitled “Measurement-based method of optimizing the placement of antennas in a RF distribution system” by David M. Cutrer, John B. Georges, and Kam Y. Lau, 1997.
[10]. Patent No WO2004086783A1 entitled “Node placement method within a wireless network, such as a wireless local area network” by Leonid Kalika, Alexander Berg, Cyrus Irani, Pavel Pechac and Ana Laura Martinez, 2004.
[11]. Patent No US20080280565A1 entitled “Indoor coverage estimation and intelligent network planning” by Vladan Jevremovic, Arash Vakili-Moghaddam and Serge Legris, 2008.
[12]. Patent No US2008/0026765A1 entitled “Tool for multi-technology distributed antenna systems” by Hugo Charbonneau, 2008.
[13]. U.S. Pat. No. 6,754,488B1 entitled “System and method for detecting and locating access points in a wireless network” by King L. Won, Kazim O, Yildiz and Handong Wu, 2004.
[14]. Patent No WO2008042641A2 entitled “Relative location of a wireless node in a wireless network” by Hart Brian, Donald and Douglas Bretton Lee, 2008.

As illustrated with the above list of patents and patent applications, there are many methods for placing antennas or access points employed in the wireless network design. Generally, RF signal strength is monitored manually at different positions utilizing test antennas and a wireless network analyzer, considering the distance between access points, coverage values measured, corner locations, floor area, etc.

A problem with network design methods of the prior art is that minimum cost and optimal placement are not guaranteed. Additionally, there are no methods for automatic determination of antenna numbers and locations by mathematic analysis for 2G Global System for Mobile Communications (GSM), 3G Wideband Code Division Multiple Access (WCDMA) or Code Division Multiple Access 2000 (CDMA2000), or 4G 3GPP Long Term Evolution (LTE), Wireless Fidelity (WiFi), and Worldwide Interoperability for Microwave Access (WiMAX) network component multi-service wireless network design. Yet a further problem is that many of the methods of the prior art are limited to outdoor wireless network design.

### SUMMARY OF INVENTION

According to an aspect, the present invention provides a computer implemented method for design of a communications network, the method including:
generating, by a computer processor, a plurality of receiver points;
generating, by a computer processor, a target received signal strength for each receiver point of the plurality of receiver points;
determining, by a computer processor, a predicted number of antennas based on a size of the communications network and a coverage area of an antenna;
determining, by a computer processor, a location for each antenna of the predicted number of antennas;
comparing, by a computer processor, an estimated received signal strength for each receiver point with the target received signal strength for the receiver point;
generating a revised predicted number of antennas based upon at least one of the comparisons of target received signal strength and estimated received signal strength.

The method provides a user with a powerful design environment for 2G/3G/4G multi-service wireless networks, for example, which allows users to quickly and easily achieve an efficient and low cost network design in indoor and outdoor areas.

According to an embodiment, the communications network includes at least one of a Global System for Mobile Communications (GSM), Wideband Code Division Multiple Access (WCDMA), Code Division Multiple Access 2000 (CDMA2000), 3GPP Long Term Evolution (LTE) and Worldwide Interoperability for Microwave Access (WiMAX) network component.

According to another embodiment, the target received signal strength for WCDMA, CDMA2000, LTE, WiFi and WiMAX is generated based upon at least one of a minimum data rate, an orthogonality factor, an interference, a receiver noise power, a MIMO mode, a subcarrier number, a subframe/frame length and a symbol number per subframe/frame.

According to yet another embodiment, the method further includes:

determining that at least one receiver point of the plurality of receiver points is covered by a pre-existing antenna;

removing the at least one receiver point from the plurality of receiver points.

According to an embodiment, the plurality of receiver points are generated based at least partly on an accuracy or time-limitation requirement.

According to an embodiment, the step of determining a location for each antenna of the predicted number of antennas includes:

determining an initial location for each antenna based at least partly on an antenna path loss between the antennas; and

updating, based upon at least a receiver path loss between at least one receiver point and the antennas, the location for each antenna.

According to an embodiment, the receiver path loss is determined based upon a path attenuation between the antenna and the receiver point, including at least one of a free space path loss, a buildings loss, a wall penetration loss, a log-normal fade margin and an interference margin.

According to an embodiment, the initial location for each antenna is determined using at least a random component.

According to an embodiment, the steps of determining a location for each antenna, generating an estimated received signal strength for each receiver point and comparing the estimated received signal strength for each receiver point with the target received signal strength for the receiver point are performed a plurality of times, wherein the determining a location for each antenna is performed using different initialisation parameters each of the plurality of times.

According to an embodiment, the step of updating the antenna locations includes:

identifying an obstacle within a specified distance to the antenna;

calculating a distance between the obstacle and the antenna; and

updating the antenna location based upon the distance between the obstacle and the antenna.

According to an embodiment, the step of updating the antenna locations includes:

identifying an antenna within a non-placement area; and

updating the antenna location based upon the non-placement area.

According to an embodiment, the receiver points are generated equally spaced across the network coverage area. Advantageously, the spacing is 0.5 m, 1 m or 2 m.

According to an embodiment, the receiver points are grouped into a first group and a second group, wherein the first and second groups having at least one of a differing target received signal strength, and a differing target coverage.

According to an embodiment, the predicted number of antennas is increased until a target received signal strength and coverage requirement is met.

According to an embodiment, the method further includes generating a report, on a computer processor, and outputting the report on a computer interface, the report specifying at least an antenna number and antenna locations.

According to another aspect, the invention provides a system for communication network design including:

a user interface module for receiving network related parameters;

a receiver point generation module, for generating a plurality of receiver points based upon at least one of the network related parameters;

a target strength generation module, for generating a target received signal strength for each receiver point of the plurality of receiver points;

an antenna prediction module, for generating a predicted number of antennas based the network related parameters;

an antenna location module, for determining a location for each antenna of the predicted number of antennas;

a signal strength estimation module, for generating an estimated received signal strength for each receiver point of the plurality of receiver points, based upon the predicted number of antennas and the location of each antenna of the predicted number of antennas;

a signal strength comparison module, for comparing the estimated received signal strength for each receiver point with the target received signal strength for the receiver point;

a control module, for controlling the an antenna prediction module, the antenna location module, the signal strength estimation module, and the signal strength comparison module such that the antenna numbers and locations are revised, and signal strengths are determined and compared until a predetermined criteria are met.

According to yet another aspect, the invention provides a non-transitory computer readable medium having stored thereon computer executable instructions for performing the method described above.

### BRIEF DESCRIPTION OF THE FIGURES

To assist in understanding the invention and to enable a person skilled in the art to put the invention into practical effect, preferred embodiments of the invention are described below by way of example only with reference to the accompanying drawings, in which:

FIG. 1A and FIG. 1B illustrate receiver points with different spacing sizes (4 m in the left and 2 m in the right);

FIG. 2 illustrates an indoor floor plan example;

FIG. 3 illustrates an automatic determination of antenna numbers and locations (A-DANL) method;

FIG. 4 illustrates an initial distribution of antenna locations (marked by solid dots);

FIG. 5 illustrates A-DANL results with path loss prediction thematic map based on different sets of initial random antenna locations;

FIG. 6 illustrates obstacle (wall/pillar) avoidance;

FIG. 7 illustrates non-placement area avoidance;

FIG. 8 illustrates A-DANL results according to different distance requirements to obstacles;

FIG. 9 illustrates A-DANL results according to different non-placement areas with grids;

FIG. 10 illustrates A-DANL results for the floor plan with pre-existing antennas marked as pentagrams;

FIG. 11 illustrates A-DANL results according to RSSI requirements for different 3G services;

FIG. 12 illustrates A-DANL results according to different coverage requirements;

FIG. 13 illustrates A-DANL results according to different RSSI requirements of multi-area in one coverage area;

FIG. 14 illustrates A-DANL results according to RSSI requirements for different areas with H (high) and L (low) RSSIs;

FIG. 15 illustrates A-DANL results according to throughput and Ec/Io requirements for 12.2 kbps data rate in 3G system;

FIG. 16 illustrates A-DANL results according to throughput and Ec/Io requirements for 144 kbps data rate in 3G system;

FIG. 17 illustrates A-DANL results according to throughput and Echo requirements for 384 kbps data rate in 3G system;

FIG. 18 illustrates required SINR per subcarrier according to peak data throughput requirements in a 4G system;

FIG. 19 illustrates Required RSSI per subcarrier according to peak data throughput requirements in 4G system;

FIG. 20 illustrates required RSSI per subcarrier according to peak data throughput requirements in 4G system;

FIG. 21 illustrates a computer system where the methods of the present invention may be implemented;

FIG. 22 illustrates different sizes of antenna coverage area for different 3G services and frequency bands;

FIG. 23 illustrates efficiency of placing antennas in the A-DANL method; and

FIG. 24 illustrates three coverage areas in the same floor plan in the A-DANL method.

Those skilled in the art will appreciate that minor deviations from the layout of components as illustrated in the drawings will not detract from the proper functioning of the disclosed embodiments of the present invention.

### DETAILED DESCRIPTION OF EMBODIMENTS OF THE INVENTION

Embodiments of the present invention comprise network planning methods. Elements of the invention are illustrated in concise outline form in the drawings, showing only those specific details that are necessary to the understanding of the embodiments of the present invention, but so as not to clutter the disclosure with excessive detail that will be obvious to those of ordinary skill in the art in light of the present description.

In this patent specification, adjectives such as first and second, left and right, front and back, top and bottom, etc., are used solely to define one element or method step from another element or method step without necessarily requiring a specific relative position or sequence that is described by the adjectives. Words such as “comprises” or “includes” are not used to define an exclusive set of elements or method steps. Rather, such words merely define a minimum set of elements or method steps included in a particular embodiment of the present invention.

According to one aspect, the invention resides in a computer implemented method for design of a communications network, the method including: generating, by a computer processor, a plurality of receiver points; generating, by a computer processor, a target received signal strength for each receiver point of the plurality of receiver points; determining, by a computer processor, a predicted number of antennas based on a size of the communications network and a coverage area of an antenna; determining, by a computer processor, a location for each antenna of the predicted number of antennas; generating, by a computer processor, an estimated received signal strength for each receiver point of the plurality of receiver points, based upon the predicted number of antennas and the location of each antenna of the predicted number of antennas; comparing, by a computer processor, the estimated received signal strength for each receiver point with the target received signal strength for the receiver point; generating a revised predicted number of antennas based upon at least one of the comparisons of target received signal strength and estimated received signal strength.

The present invention enables the determination of antenna numbers and locations to satisfy the voice and data services requirements in 2G/3G/4G communication networks, for example.

An embodiment of the present invention, referred to as Automatic Determination of Antenna Numbers and Locations (A-DANL), generates a solution for an area to be covered with known predicted path attenuation of a plan of site by prediction models (COST 231/Ray Tracing), antenna types and 2G/3G/4G services requirements, and is described in detail below.

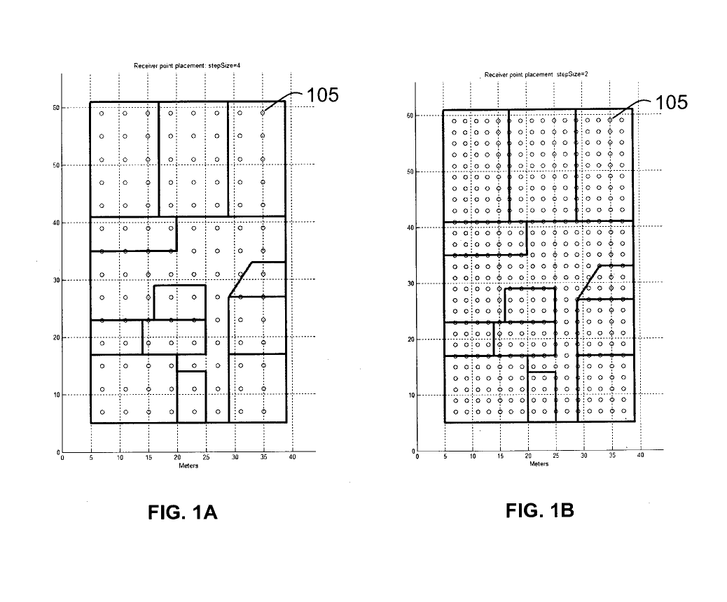

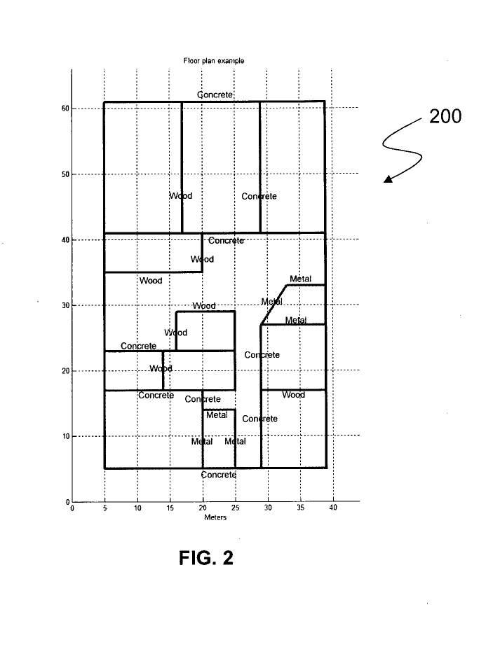

Instead of selecting receiver points manually in the area, A-DANL generates receiver points automatically. FIG. 1A and FIG. 1B illustrate a plurality of receiver points 105 automatically generated at spacings of 4 m and 2 m respectively. If a smaller spacing is chosen, e.g., 0.5 m, most possible indoor and outdoor handset locations can be included in generated receiver points. The accuracy of antenna locations is dependent on numbers of receiver points to be covered. The receiver points could be N portable handsets distributed in the service area and the objective is to place K antennas in this area to provide signal coverage for N handsets.

The coverage percentage is calculated by comparing the weakest received signal of N handsets and the target RSSI (received signal strength indication). RSSI in the invention is the received signal strength of the desired signal only. For data throughput coverage, the coverage percentage is calculated by the lowest data rates and the target data rates. More receiver points, generated by small spacing size between then, result in more accurate antenna locations, but more time-consuming process.

An example of a plan of site, an indoor floor plan with obstacle materials 200 is shown in FIG. 2. The signal attenuation through the metal is more than that through concrete and wood normally.

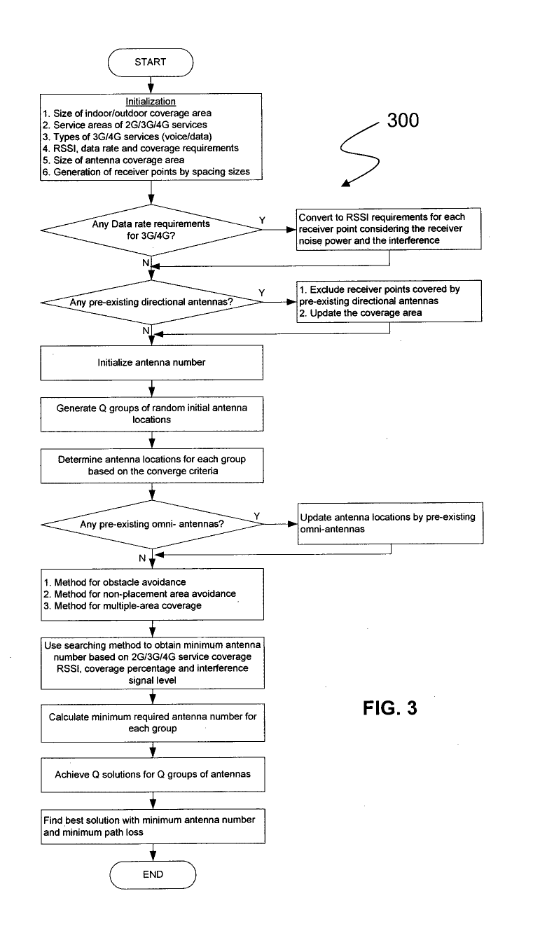

FIG. 3 depicts a flow chart of the A-DANL method 300 according to an embodiment of the present invention.

Total indoor/outdoor coverage area and coverage area of antennas in the initialization step of A-DANL are used to calculate the minimum number of antennas required, as initial antenna number. The selection of the initial antenna locations starts with the random selection of first one. Afterwards, the initial location of other antennas will be chosen with maximum path losses between all antennas. A number of groups, Q groups, of random initial antenna locations are generated. Obviously, the antenna locations in Q groups are different.

If multiple services, such as voice and data, are supported in the same coverage area, the target RSSI will be that of data service with the highest data rate considering the interference from the estimation or measurement. If multiple services are supported in different coverage areas, different service areas with their coverage requirements will be specified in the initialization.

If there are directional antennas installed, before the calculation of the initial antenna number, the receiver points and the coverage areas are updated by the directional antenna coverage.

According to the convergence criteria and the pre-existing omni-directional antenna in each group, the antenna locations are determined, and updated considering the obstacles, non-placement areas and multiple area coverage. The required antenna number will be updated and minimized by the method to deal with different multi-service coverage requirements in the A-DANL method. The final solution of A-DANL will be the one with minimum antenna numbers from Q solutions.

The path loss (in dB) between a receiver point and an antenna in a 2D indoor floor plan can be given by COST 231 Multi-Wall model (Final report for COST Action 231, Digital mobile radio towards future generation systems, Chapter 4),

$$PL = {PL}_{FS} + {\sum }_{i = 1}^{I} {k}_{wi} {L}_{wi} + {L}_{c} , \qquad ( 1 )$$

where free space path loss (in dB) is

$${PL}_{FS} = 10 {log}_{10} [ {( \frac{4 π f}{c} )}^{2} {d}^{n} ] ,$$

and
n: Path loss exponent
d: Distance between transmitter and receiver
f: Frequency
c: Speed of light
k_{wi}: Number of penetrated walls of type i
L_{wi}: Path loss of wall type i to be optimized along with the measured path loss data
I: Number of wall types
L_{c}: Constant path loss to be determined with the measured path loss data.

For outdoor areas, the path loss can be given by COST 231-Hata model or COST 231—Walfisch-Ikegami Model. As a whole, for a specified frequency band, the generalized path loss utilized in the invented A-DANL is the maximum path attenuation, including not only the predicted free space path loss, buildings and walls penetration loss, but also log-normal fade margin, interference margin and body loss. In the network design, target RSSI requirement is the key KPI (key performance indicator). If the antenna EIRP is given, i.e., 0 dBm, the RSSI requirement will be converted to the maximum path loss requirement by PLₘₐₓ=EIRP−RSSI_{target}. If there are data rate requirements in 3G and 4G systems, these requirements will be converted to RSSI requirement considering the total receiver noise power and interference, to be analyzed in Section 7 and 8.

According to an embodiment of the present invention, the A-DANL method consists of nine sections described below. As will be understood by a person skilled in the art, not all of the below sections need be present.

### 1. Calculation of Antenna Coverage Area and Initial Antenna Number

If the maximum allowed path loss between the antenna and the receiver points is set as L dB, the area of the antenna coverage φ can be calculated by the free space path loss formula,

$$ϕ = {π10}^{\frac{L - 20 {log}_{10} ( \frac{4 π f}{c} )}{5 n}} , \qquad ( 2 )$$

The antenna coverage area depends on the frequency band and path loss exponent.

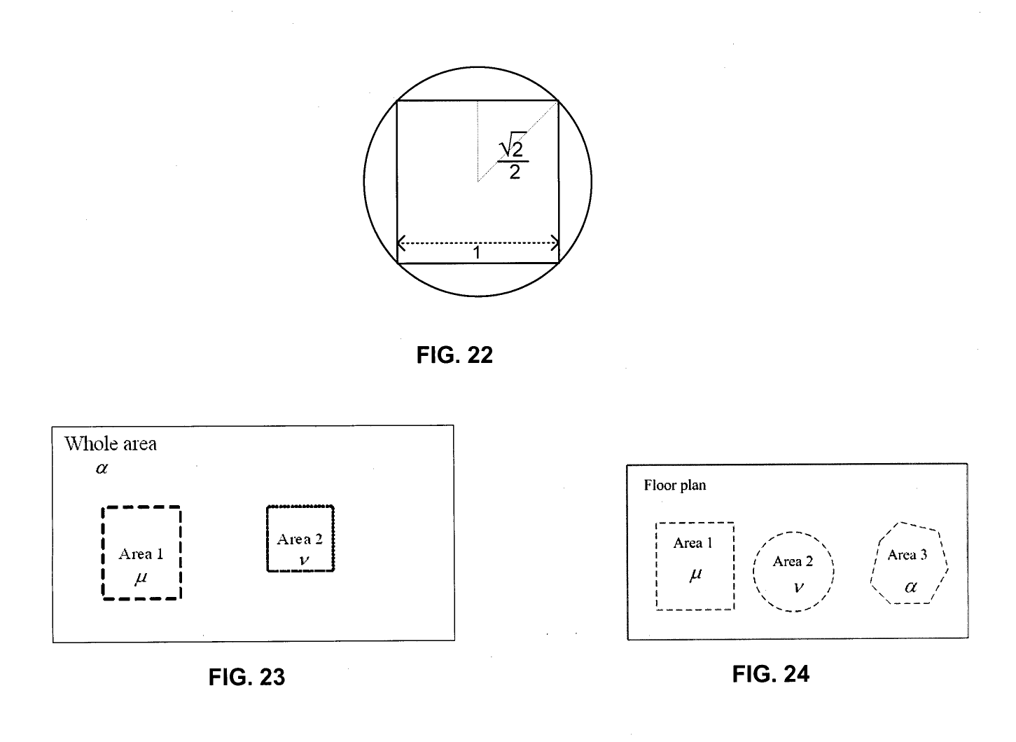

In a plan of site without any obstacles, the required antenna number is considered as the minimum number, used as the initial number. For different 3G services and frequency bands, the sizes of antenna coverage area are different. Assuming that the coverage area of an antenna is π/2, and the square site area to be covered is 1, a circle area should be π/2=1.57 times of the square area for the circle to cover a square completely, as shown in FIG. 22.

Therefore, the approximate minimum number of antenna, Kₘᵢₙ, to be placed, can be derived from Kₘᵢₙ=ψ×1.57/φ, where the site area to be covered is ψ.

The initial antenna number could be any non-negative value, however, which will downgrade the A-DANL performance.

### 2. Determination of Antenna Numbers and Locations

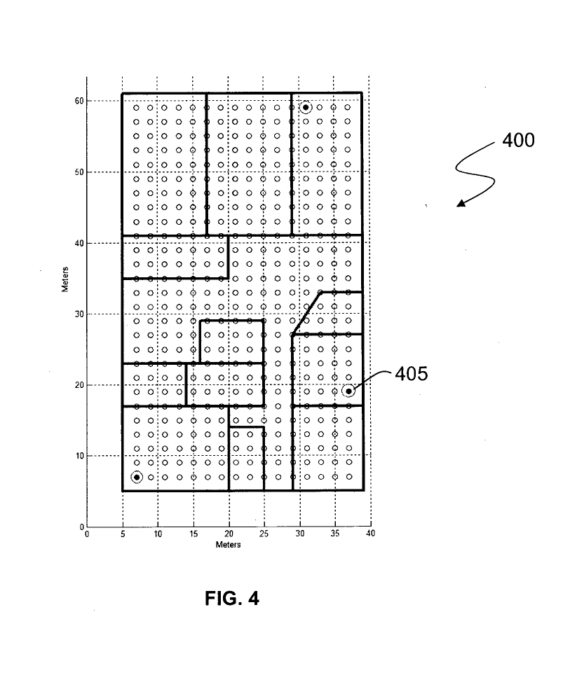

Initial antenna locations are selected from the receiver points based on very specific probabilities. The first antenna location is chosen uniformly at random from the receiver point set, after which each subsequent antenna location is selected from the remaining receiver points according to the probability proportional to its least path loss squared to the point's “closest” antenna. “Closest” means they have the least path loss, instead of least Euclidean distance, between them. An example initialization of antenna locations 400 is shown in FIG. 4. Antennas are initialized at initial locations 405 such that path loss is as much as possible between them.

The initialization of antenna locations is performed Q times and thus gives out Q possible initial antenna locations randomly, which results in Q solutions. In consequence, the best A-DANL solutions could be found from them in terms of minimum antenna count and minimum path loss.

At any given time, let PL(r) denote the least path loss from a receiver point, r∈R, to the “closest” center, c, we have already chosen. r and c have two-dimensional vectors, (rₓ,r_{y}) and (cₓ,c_{y}), representing a receiver point location and an antenna location respectively. The following steps from (2.1) to (2.3) describe the antenna location initialization, which will run Q times to generate Q antenna initializations.

2.1). From the receiver point set, R, choose a receiver point location, r₁, uniformly at random, as an antenna location to be included in the defined antenna selection set Λ.

2.2). Assuming

$${Γ}_{j} = \frac{{PL ( {r}_{j} )}^{2}}{{\sum }_{{r}_{i} ∈ R} {RL ( {r}_{i} )}^{2}} ,$$

choose the next antenna location, rⱼ∈R and rⱼ∉A, which results in

Γⱼ=max{Γ₂,Γ₂, . . . ,Γⱼ, . . . ,Γ_{K}}. (3)

Then rⱼ is contained into Λ.

2.3). Repeat Step (2.2) until the all K antenna locations have been chosen and included in Λ.

The antenna location determination is an iterative process described in steps from (2.4) to (2.11). Once the locations of the receiver points are chosen as antenna locations initially with the antenna count, some area with receiver points is covered by the antenna which has the least path loss to the receiver points compared with other antennas. The receiver point group covered by each antenna is used to calculate the “centroid” location as the updated antenna location in the iteration. The iterations of antenna location update are terminated when the receiver points covered by each antenna keep changeless, which means the iteration converges.

2.4). For each antenna, cₖ, k∈K, define the group Rₖ={r_{i,k}}ᵢ₌₁^{I}^{ₖ} from R to be the set of receiver points covered by cₖ, where i=1, 2, . . . , Iₖ and Iₖ is the number of receiver points covered by the antenna cₖ. I is the total number of receiver points in R and

$${{\sum }_{k = 1}}^{K} {I}_{k} = I .$$

2.5). For each antenna, cₖ, k∈{1, 2, . . . , K}, update the location of antenna cₖ with the coordinates of (c_{k,x},c_{k,y}), the “centroid” of the receiver points in Rₖ,

$$\{ \begin{matrix}{c}_{k , x} = {r}_{1 , x} \cdot \frac{PL ( {r}_{1 , k} )}{{\sum }_{all {r}_{i} ∈ {cell}_{k}}^{{I}_{k}} PL ( {r}_{i , k} )} + {r}_{2 , x} \cdot \frac{PL ( {r}_{2 , k} )}{{\sum }_{all {r}_{i} ∈ {cell}_{k}}^{{I}_{k}} PL ( {r}_{i , k} )} + … + {r}_{{I}_{k} , x} \cdot \frac{PL ( {r}_{{I}_{k} , k} )}{{\sum }_{all {r}_{i} ∈ {cell}_{k}}^{{I}_{k}} PL ( {r}_{i , k} )} \\ {c}_{k , y} = {r}_{1 , y} \cdot \frac{PL ( {r}_{1 , k} )}{{\sum }_{all {r}_{i} ∈ {cell}_{k}}^{{I}_{k}} PL ( {r}_{i , k} )} + {r}_{2 , y} \cdot \frac{PL ( {r}_{2 , k} )}{{\sum }_{all {r}_{i} ∈ {cell}_{k}}^{{I}_{k}} PL ( {r}_{i , k} )} + … + {r}_{{I}_{k} , y} \cdot \frac{PL ( {r}_{{I}_{k} , k} )}{{\sum }_{all {r}_{i} ∈ {cell}_{k}}^{{I}_{k}} PL ( {r}_{i , k} )} ,\end{matrix} \qquad ( 4 )$$

2.6). Path losses to all receiver points from their antennas are recalculated with updated antennas based on the path loss prediction models.

2.7). Repeat steps from (2.4) to (2.6) until the iteration converges with stable receiver points in {R₁, R₂, . . . , R_{K}}.

2.8). The RSSI for each receiver point is calculated by the predicted path loss and assumed antenna EIRP, and is compared with the target RSSI of each receiver point for the coverage percentage calculation.

2.9). If the target RSSI coverage percentage is satisfied in (2.8), the antenna number, K, will be reduced to be K/2 for another process round.

2.10) Steps from (2.4) to (2.9) are repeated till the coverage percentage meets the target coverage percentage exactly with the updated antenna numbers Kₐ which results in P≧P_{target} while P<P_{target} with K−1, if P is the coverage percentage and P_{target} is the target percentage.

2.11). If the target RSSI coverage percentage is not satisfied in (2.8), the antenna number, K, should increase to be 2K. Steps from (2.4) to (2.10) are repeated till the coverage percentage meets the target coverage percentage exactly with the updated antenna numbers.

The effect to the different coverage percentages by the numbers of antenna will be analyzed in Section 6. For each group of antenna locations from Q groups, the steps from (2.1) to (2.11) are processed and Q solutions are achieved. If PLₘₐₓ is the maximum path loss between one antenna and its covered receiver point in one solution, the final solution is the one with the minimum PLₘₐₓ selected from those with the minimum antenna count required.

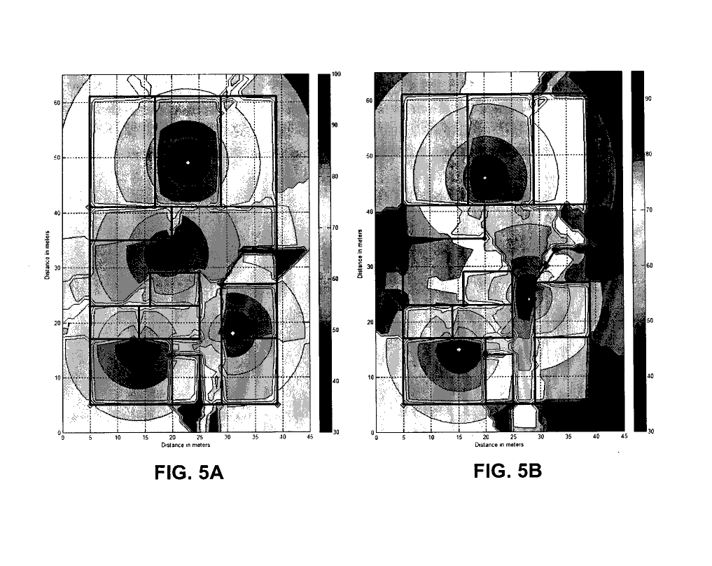

FIG. 5A gives the A-DANL result based on one group, meaning that Q=1. In terms of same requirements, including target RSSI, coverage, minimum placement distance to obstacles and antenna EIRP, the solution with fewer antennas required is achieved if Q=20 as shown in FIG. 5B. Fewer antennas and less installation cost are at the price of time-consuming process. The network designer can find a trade-off between the installation cost and the processing time. More group numbers, less antennas required.

### 3. Obstacle and Non-Placement Area Avoidance

In general, there are many obstacles, i.e., walls, in the whole coverage area. Additionally, some areas are not desirable as they are either unavailable or need more cost for antenna installation. However, the calculated antenna locations from Section 2 maybe coincide with those obstacles or non-placement areas. For that reason, the following methods are proposed to guarantee the antennas to be located the available positions with a predefined distance, h, to obstacles and the boundary of non-placement areas.

### Obstacle Avoidance

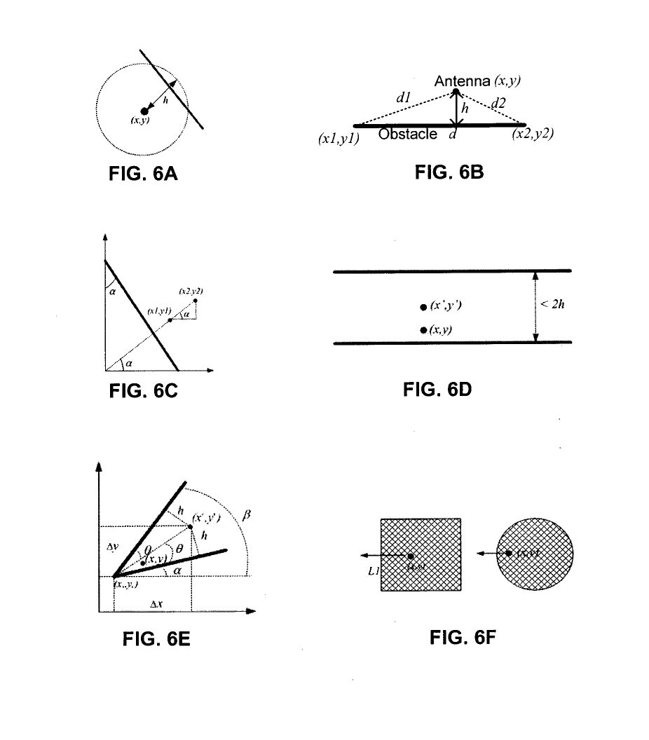

According to an embodiment, the invention makes use of a search method to find obstacles within a defined distance h of each antenna. As shown in FIG. 6A, antenna (x, y) is supposed as a centre of a circle with the radius of h, those obstacles having intersections with the circle are recorded for antenna movement in the next step. Each obstacle or its border can be considered as a line segment and the distance to the antenna is calculated from Heron's formula,

$${h}^{′} = \frac{2 \sqrt{w ( w - d 1 ) ( w - d 2 ) ( w - d )}}{d} , \\ where w = \frac{d 1 + d 2 + d}{2} \qquad ( 5 )$$

with known d, d1 and d2 as shown in FIG. 6B. In order to keep the minimum distance from the antenna to the obstacle nearby equal to h, the antenna should shift (h-h′) from (x, y) to (x′, y′), described in FIG. 6C. The updated antenna location is

$$\{ \begin{matrix}{x}^{′} = x + ( h - {h}^{′} ) \cdot cos α \\ {y}^{′} = y + ( h - {h}^{′} ) \cdot sin α ,\end{matrix} \\ where α = arctan \frac{y}{x} . \qquad ( 6 )$$

If one antenna is placed in the space between two parallel obstacles of a long corridor, the width of which is less than 2 h, shown in FIG. 6D, the antenna is to be moved to the middle position, (x′, y′), between the two obstacles. FIG. 6E gives an example that one antenna is located at a sharp corner and the antenna is much closer to both obstacles. Accordingly, the position, (x′, y′), with the same distance, h, to the obstacles should be the updated antenna location. With known coordinates of obstacles, {α,β} can be calculated and

$$θ = \vert \frac{β - α}{2} \vert$$

accordingly. Therefore, the updated antenna location is

$$\{ \begin{matrix}{x}^{′} = {x}_{0} + \frac{h}{sin θ} \cdot cos ( \frac{α + β}{2} ) \\ {y}^{′} = {y}_{0} + \frac{h}{sin θ} \cdot sin ( \frac{α + β}{2} ) ,\end{matrix} \qquad ( 7 )$$

where (x₀,y₀) is the intersection point of the two obstacles. FIG. 8A and FIG. 8B give A-DANL results with h of 1 m and 2 m respectively. Antennas need to be moved further from their calculated locations when longer minimum distance limitation to obstacles is required. In consequence, more antennas are required possibly. As shown in FIG. 8A and FIG. 8B, the final antenna number for h=2 m is one more than that for h=1 m.

If the obstacle is a thick pillar, shown in FIG. 6F, the pillar area can be considered as a non-placement area for the antenna installation, which is solved by the method of non-placement area avoidance described below.

### Non-Placement Area Avoidance

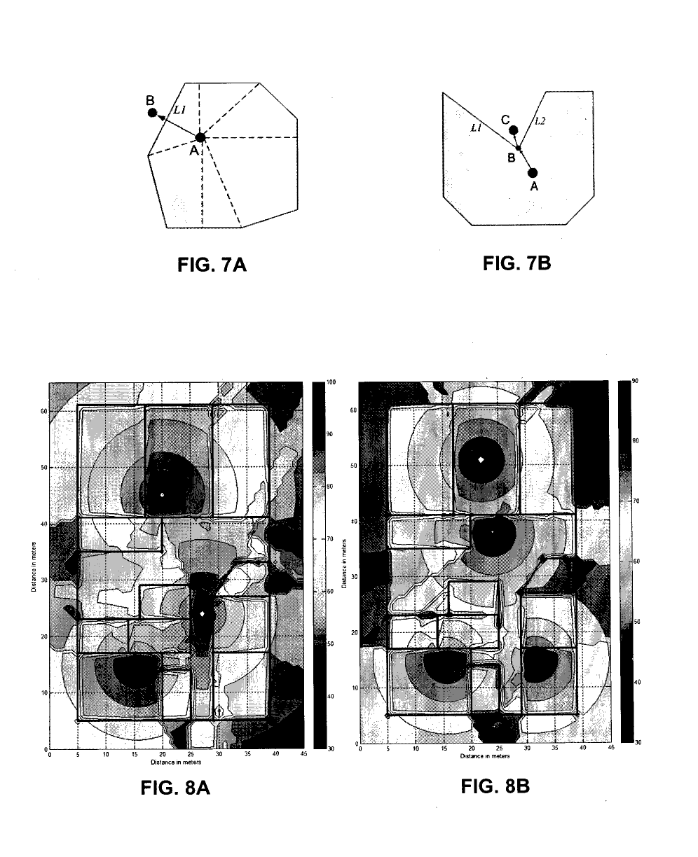

The non-placement area could be a polygon with any shapes, classified to convex and concave types, shown in FIG. 7A and FIG. 7B. At first, the available shifting directions are selected because some boundaries of non-placement area could coincide with the floor plan boundaries. Secondly, the distance from the antenna to each border of the polygon from all available directions is calculated by Eq. (5) and the direction with the minimum distance is chosen. Therefore, in FIG. 7A, the antenna A will be moved to B location with a certain distance from the border Ll along the perpendicular line to Ll. If the non-placement area is a cylinder pillar area, the movement direction is from the antenna to the point on the circle nearest to the antenna.

However, there is a special case that if the non-placement area is concave and the antenna A is placed close to the concave vertex B, as described in FIG. 7B. In this case, the perpendicular line with the minimum length is the one from antenna A to Ll, but it doesn't have intersection point with Ll. Consequently, the perpendicular direction to Ll is unavailable. To move the antenna A out of the area with some distance from boundaries, the updated antenna location C is calculated by Eq. (7) based on the concave vertex B.

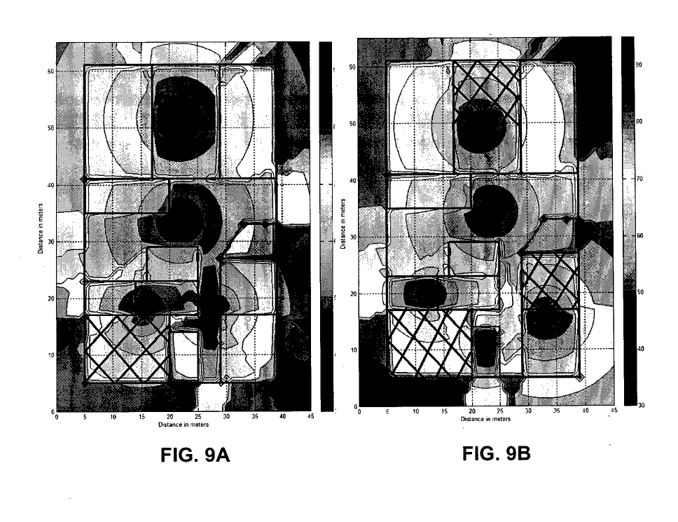

If the polygon border is an obstacle or wall, the updated antenna will be placed with the distance of h to it; otherwise, the antenna can be located at this border. Similar to the impact to the antenna numbers by the obstacle avoidance method, the defined non-placement areas lead to that more antennas being required to provide the target RSSI and 99% coverage percentage, as illustrated in FIG. 9A and FIG. 9B.

4. Automatic Determination of Antenna Numbers and Locations with Pre-Existing Antennas

If the A-DANL is performed in an area with some pre-existing antennas, or there are some fixed locations for antenna installation, several steps would be processed to solve these problems.

### Pre-Existing Directional Antenna

If the pre-existing antenna is not omni-directional, according to the target RSSI requirement, the receiver points covered by the installed directional antennas are excluded in A-DANL process at first. Then, the initial antenna number, Kₘᵢₙ′, is updated by the remaining coverage area ψ′. Thus, the A-DANL is performed based on the remaining uncovered receiver points.

This method plays an important role in the situation of reducing the spillage surrounding the building or coverage area. For example of indoor design, the maximum spillage to the roads is −85 dBm in 2G networks and −100 dBm in 3G networks. If the antenna locations calculated by the A-DANL method don't satisfy the spillage requirement, directional antennas should be placed manually near the boundary of the coverage area, then A-DANL will be processed based on the remaining uncovered receiver points.

### Pre-Existing Omni-Directional Antenna

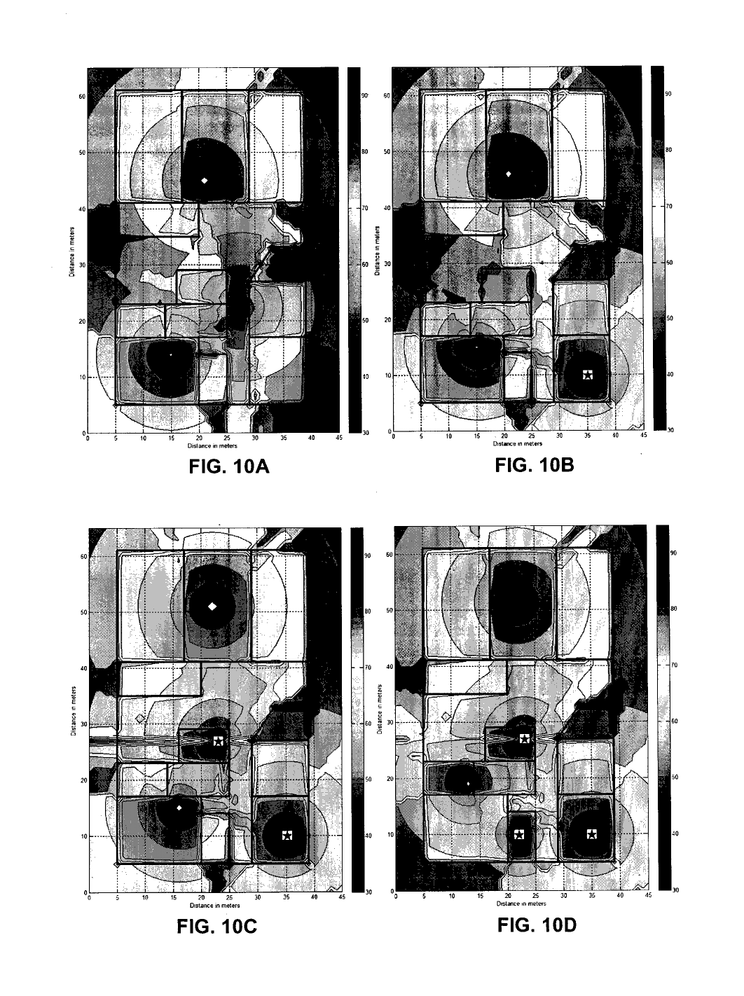

If the number of the pre-existing antennas or fixed locations, K′, is lager than the initial number of antennas, Kₘᵢₙ, then the initial number will be set to K′. After the antenna locations are derived from the above steps, the path loss between each of them and each pre-existing antenna or assumed antenna at each fixed location is calculated. The antenna with the minimum path loss to the pre-existing antenna location will be moved to this pre-existing or fixed location. If the pre-existing antennas were installed previously at the positions far away from the calculated locations, it is possible that more antennas could be required to ensure the coverage performance, as illustrated in FIGS. 10A, 10B, 10C and 10D. Especially in FIG. 10D, two more antennas are required when there are three pre-existing antennas at non-optimal locations than those in FIG. 10A and FIG. 10B.

In addition to this, similar processes to that for pre-existing directional antenna could be applied, which are excluding receiver points covered by pre-existing omni-antennas and performing A-DANL based on the remaining uncovered receiver points. These two methods could achieve different antenna numbers and locations in different situations, the best of which will be chosen according to the different design criteria.

5. Antenna Number Minimization with RSSI and Coverage Requirements

In 3G or networks beyond 3G, multiple services with different data rates may be supported and each may have a respective receiver sensitivities or maximum path loss requirement. Regardless of technologies to enhance the receiver performance, high receiver sensitivities for high-speed data rate transmissions can be guaranteed by high RSSI values, and lower RSSI leads to less received power to support tow-speed services for a given interference level. In another word, high-speed data transmission with high target RSSI needs more antennas than low-speed transmission with low target RSSI.

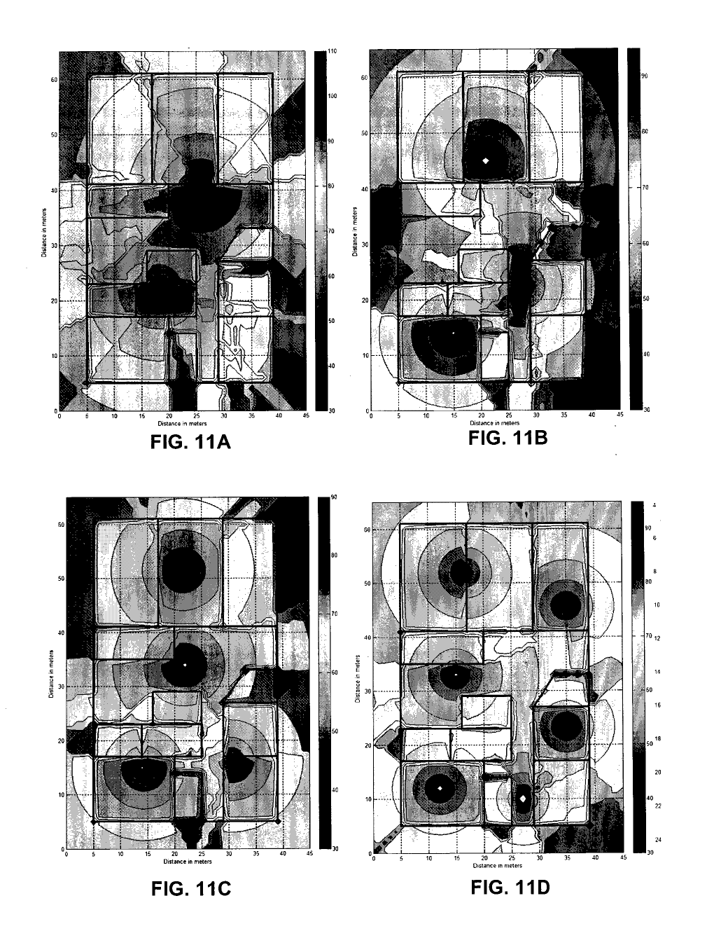

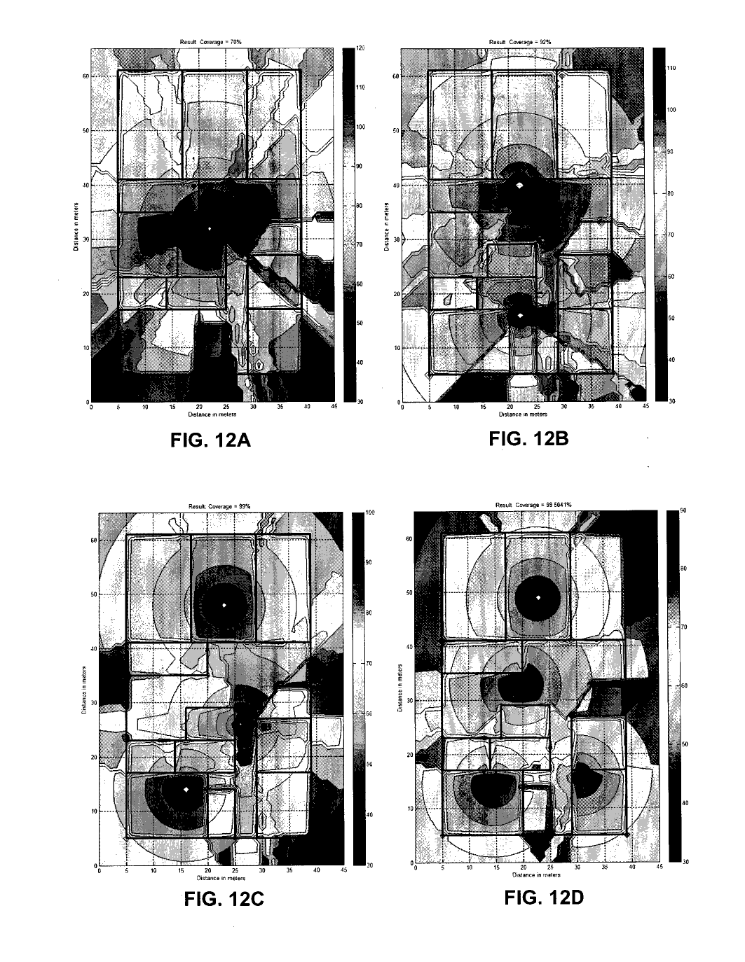

The procedure of antenna number minimization is located at the last step for one solution group of the A-DANL, shown in FIG. 3. According to the final antenna locations, the effective RSSI of each receiver points is calculated in dBm considering the log-normal fade, body loss and noise, and compared with the target RSSI. The coverage percentage is the ratio of receiver point number with target RSSI values over those with unsatisfied RSSIs. If the coverage requirement is not achieved, the antenna number will increase and all steps will be repeated until the target coverage percentage with the target RSSI is satisfied. In case too many loops occur due to many obstacles in the service area, the searching method described in steps from (2.9) to (2.11) is applied to update the antenna number in each loop. Assuming that target RSSIs of −95 dBm and −85 dBm are for voice transmission and high-speed data needs at least −80 dBm RSSI, FIG. 11A and FIG. 11B depict that only two antennas are required for RSSI=−95 dBm and three antennas for RSSI=−85 dBm when the target coverage is 99%. To cover 99% of the area for data transmissions, four and six antennas are needed for RSSI of −80 dBm and −75 dBm respectively. Referring to FIG. 12, different coverage requirements, 70%, 90%, 99% and 99.5%, give rise to 1, 2, 3, and 4 antennas with their optimal locations, given the fixed target RSSI, −85 dBm.

6. Automatic Determination of Antenna Numbers and Locations with Coexistence of Multi-Service Coverage Areas

Inside the whole area, some areas could have higher or lower data rate requirements than the whole area possibly in 3G wireless networks. For instance, there is a specified room for the wireless video conference in the whole coverage area for voice transmissions. Or a warehouse with voice coverage only is located in a floor to be covered with data of 64 kbps. One more possible case is that there is an open yard inside the indoor floor plan which is not necessary to be covered. More antennas are needed to support the high data rate in this meeting room for the first case; however, the other two cases would utilize fewer antennas for voice coverage area and the open yard coverage to save the cost. Outdoor coverage areas also have these situations. In order to save the cost, antennas should be placed efficiently. Therefore, this consideration may be incorporated into the A-DANL method discussed above. With the 99% coverage percentage, it is assumed that the target RSSI is α dBm for the whole area, μ dBm for Area 1 (wireless video conference room) and ν dBm for Area 2 (Open yard) and ν<α<μ, referring to FIG. 23.

In Area 1, the density of placed antennas is more than that in the area outside due to α<μ. On the contrary, the antenna density is the least in Area 2. In the A-DANL, the boundaries of Area 1 could be considered as virtual concrete walls with (μ-α) attenuation, absorbing the power from antennas to receiver points in Area 1, which would “drag” the antennas closed to Area 1 by the processes in Section 2. On the contrary, some amplifiers, with the gain of (α-ν), are assumed to be placed along the Area 2 boundary and the A-DANL method would place few antennas to cover this area. For the purpose of determining antenna locations automatically in the whole coverage area considering two inside areas, two fade margins are defined as the difference between the target RSSIs of the whole area and that of the two areas, f₁=μ−α and f₂=ν−α, f₂<0<f₁. In the steps of (2.2) and (2.5) in Section 2, the predicted path loss at the receiver points within Area 1 and Area 2, PL₁(r) and PL₂(r), would be updated by f₁ and f₂ respectively, meaning P\hat{L}₁(r)=PL₁(r)+f₁ and P\hat{L}₂(r)=PL₂(r)+f₂.

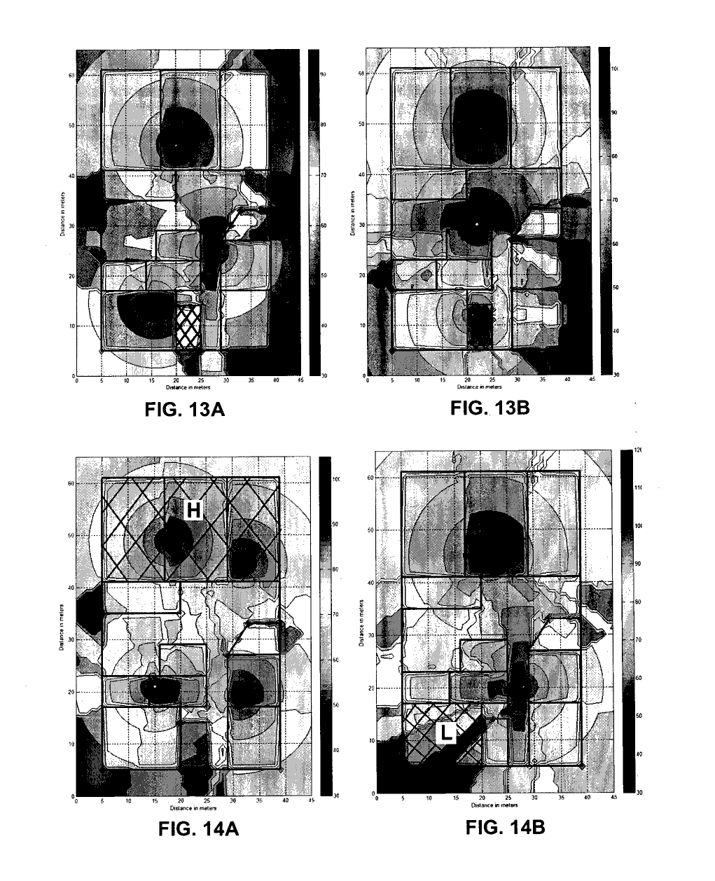

According to FIG. 13, the A-DANL method gives different antenna locations to guarantee the coverage of the whole area and the particular service areas with higher target RSSIs. Because of the priority area with the higher RSSI requirement in FIG. 13B, one antenna is placed inside this area to provide higher power for high-speed data transmissions, compared with FIG. 13A. FIG. 14A shows the results of A-DANL based on a large area, (H area), with higher RSSI requirement than the whole area. One more antenna is placed when the required RSSI is insufficient. FIG. 14B gives a floor plan in which there is a room, (L area), not required to be covered. Consequently, only two antennas are deployed to cover the remaining area.

If three coverage areas in the same floor plan are defined separately in FIG. 24, ν<α<μ, the receiver points used in A-DANL are the summation of those in the three coverage areas. And the same methods as discussed above are used to calculate the best antenna locations. Because the separated areas would share antennas to save the costs, the antennas could be outside of the coverage areas.

In addition to the method above in this section, there could be another one to determine antenna numbers and locations with coexistence of multi-service coverage areas. Antennas are placed in the area with highest target RSSI requirement at first. Afterwards, the area with the second highest target RSSI requirement is analyzed considering the antennas already placed. The rest can be done with the same manner till all coexistent multi-service areas are covered with the design requirement. These two methods could achieve different antenna numbers and locations in different situations, the best of which will be chosen according to the different design criteria.

7. Automatic Determination of Antenna Numbers and Locations with 3G Data Throughput and E_{c}/Iₒ Requirements

In 3G systems, such as WCDMA and CDMA2000, E_{c} is the average energy per PN chip on the pilot channel (PICH) while Iₒ is the total received power including signal, noise and interference as measured at mobile antennas. E_{c}/Iₒ can be calculated by

$${E}_{c} / {I}_{o} = \frac{{RxPower}_{PICH}}{( 1 - α ) RSSI + {P}_{N} + {I}_{other}} \qquad ( 8 )$$

where RxPower_{PICH} is the received power on pilot channel, α is the downlink orthogonality factor (0.4˜0.9) affected by multipath environments, P_{N} is the receiver noise power and Iₒₜₕₑᵣ is the interference from other cells in the downlink. If assuming the power on the pilot channel is 10% of the total transmission power, we have RxPower_{PICH}=0.1·RSSI. For example of WCDMA system, on the basis of the E_{c}/Iₒ analysis for multiple service in “3GPP Technical Specification 25.101”, the required E_{c}/Iₒ for 12.2 kbps (voice), 64 kbps (data), 144 kbps (data) and 384 kbps (data) in downlink multipath fading channel (Case 3) are −11.8 dB, −7.4 dB, −8.5 dB and −5.1 dB respectively. According to the required E_{c}/Iₒ for multiple services in WCDMA or CDMA2000 systems, the required RSSI (in dBm) would be obtained considering required E_{c}/Iₒ (in dB) for multi-service, the receiver noise power (in dBm) and interference (in dBm) from other cells,

$${RSSI}_{required} = 10 {log}_{10} ( {10}^{{P}_{N} / 10} + {10}^{{I}_{other} / 10} ) - 10 {log}_{10} ( \frac{0.1}{{10}^{{E}_{c} {I}_{o} / 10}} + α - 1 ) . \qquad ( 9 )$$

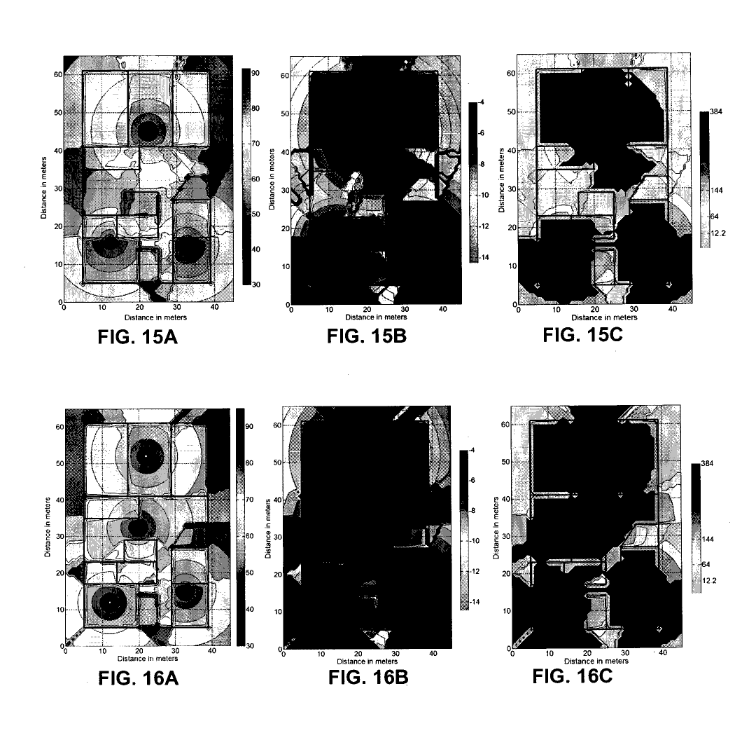

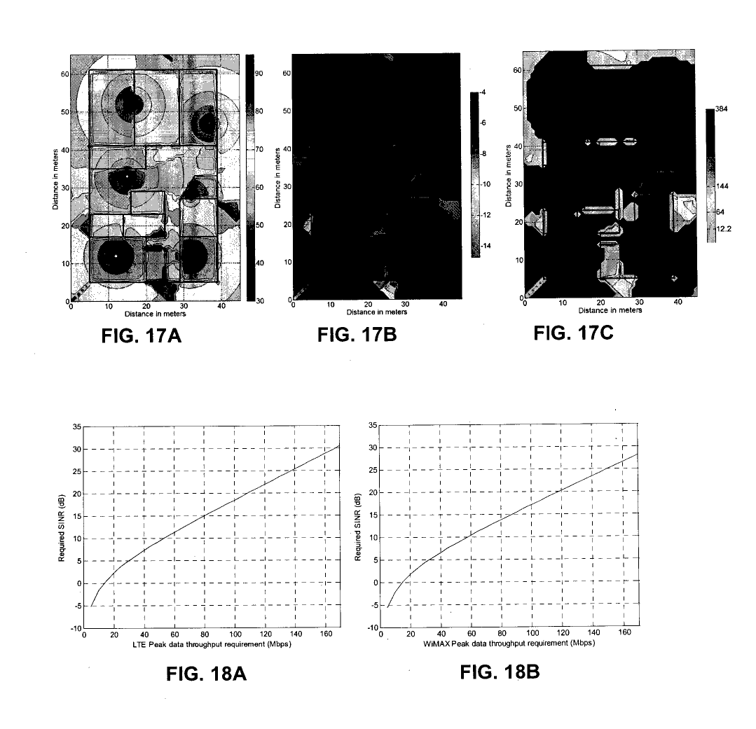

3G system using CDMA technique employs the orthogonal codes to separate users in the downlink, and the orthogonality in the received signal by the mobile remains, α=1, without any multipath propagation. However, it is inevitable that the mobile can see part of the base station signals as multiple access interference due to the delay spread. The orthogonality factor, α, is within [0.4, 0.9] in multipath environments typically. Supposing α is 0.8, the average interference from other cells is −85 dBm, mobile noise figure is 8 dB and thermal noise density is −174 dBm/Hz in a UMTS system with the chip rate of 3.84 Mcps, the receiver noise power, P_{N}=−174+8+10 log₁₀(3840000)=−100 dBm, and consequently the required RSSI are −86 dBm, −80 dBm, −79 dBm and −76 dBm for the data rates of 12.2 kbps, 64 kbps, 144 kbps and 384 kbps. Ultimately, the A-DANL with data throughput requirements is converted to the A-DANL with specific RSSI requirements for different data rates, which could be processed by the steps described in previous sections. To achieve 99% data rate coverage, the A-DANL results including the required antenna numbers and locations with path loss, Echo and throughput predictions with the data rate requirements of 12.2 kbps, 144 kbps and 384 kbps are shown in FIG. 15, FIG. 16 and FIG. 17. Obviously, more antenna numbers are installed for higher data rate requirements.
8. Automatic Determination of Antenna Numbers and Locations with 4G Data Throughput and SINR Requirements

In 4G systems, such as LTE and WiMAX, as well as WiFi, much higher data throughput can be supported owning to that some technologies are applied, i.e., OFDMA, MIMO antenna, HARQ, adaptive modulation, etc. Given the data throughput requirement for 4G systems, A-DANL will determine the required antenna numbers and locations with the consideration of receiver noise power and interference from other cells. Similar to the A-DANL with 3G data throughput requirements, the data throughput requirements will be converted to the individual RSSI per subcarrier requirements at each receiver point for A-DANL process.

The received SINR per subcarrier (signal to interference and noise ratio) in the LTE/WiMAX/WiFi downlink can be described as

$$\begin{matrix}{SINR}_{perSubcarrier} = \frac{{RSSI}_{perSubcarrier}}{{P}_{N} + {I}_{other}} {⇒}^{dB} SINR ( dB ) \\ = {RSSI}_{perSubcarrier} - 10 \cdot \\ {log}_{10} ( {10}^{{P}_{N} / 10} + {10}^{{I}_{other} / 10} )\end{matrix} \qquad ( 10 )$$

and consequently the spectral efficiency could be obtained referring to Shannon formula,

S=BW_{eff}·log₂└1+10^{(SINR}^{_{perSubcarrier}}^{-SINR}^{_{eff}}^{)/10}┘ (11)

where BW_{eff} is the bandwidth efficiency factor, SINR_{eff} is the SINR efficiency factor (Mogensen P.; Wei Na; Kovacs I. Z., Frederiksen F.; Pokhariyal A.; Pefersen KJ.; Kolding T.; Hugl K.; Kuusela M.; “LTE capacity compared to the Shannon bound”, IEEE VTC, 1234-1238, 2007), and SINR per subcarrier is in dB. According to the special efficiency, MIMO factor m, OFDM subcarrier number N, symbol number per LTE subframe (or WiMAX frame) X, the LTE subframe length (or WiMAX/WiFi frame length) L, and the control/reference signal overhead occupation ratio, b %, the peak data throughput (bps), Rate, is calculated by

$$Rate = m \cdot S \cdot N \cdot \frac{X}{L} \cdot ( 1 - b \% ) \qquad ( 12 )$$

where m would be 1, 2 and 4 if the MIMO mode is 1×1, 2×2 and 4×4 if the downlink transmission mode is transmit diversity.

The requirement conversion from data throughput to RSSI per subcarrier is performed by the reverse process from Eq. (12) to Eq. (10). To achieve the required data throughput, Rate, the required special efficiency RSSI per subcarrier (dBm) is

$${RSSI}_{req\_perSubcarrier} = 10 \cdot {log}_{10} [ 1 - {2}^{\frac{Rate}{{BW}_{eff} \cdot m \cdot N \cdot X \cdot ( 1 - b \% ) / L}} ] + 10 \cdot {log}_{10} ( {10}^{{P}_{N} / 10} + {10}^{{I}_{other} / 10} ) + {SINR}_{eff} \qquad ( 13 )$$

in A-DANL process.

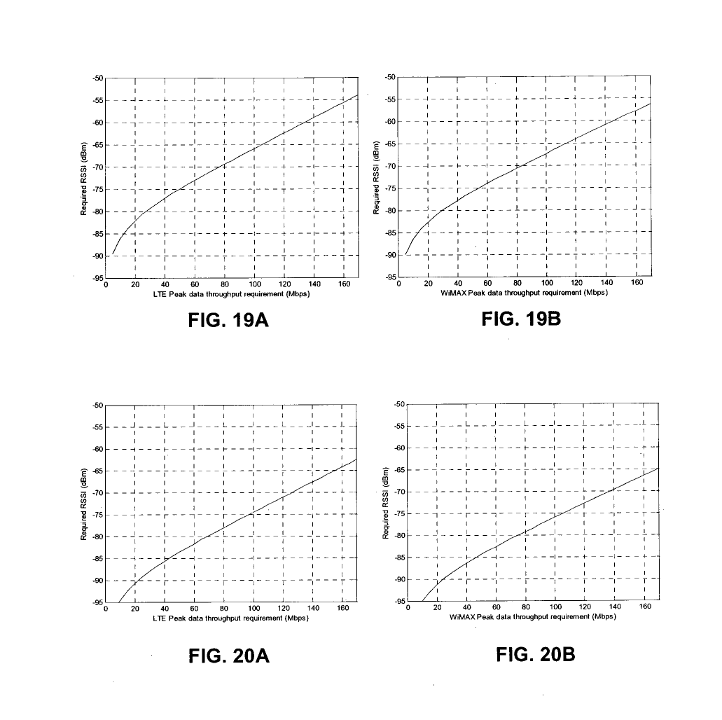

For LTE system with the bandwidth of 20 MHz, it is supposed that BW_{eff} is 0.62, SINR_{eff} is 1.5, the subcarrier number is 1200, MIMO mode is 2×2, symbol number per subframe is 14, the length of subframe is 1 ms, and the control/reference overhead occupy 15% of the subframe. For WiMAX system has the same parameters as LTE except that the subcarrier number is 2000, symbol number per frame is 48 and the length of frame is 5 ms, and b % is 19%. In terms of these settings, the required SINR per subcarrier calculated by Eq. (11)˜(13) for the data throughput from 5 Mbps to 170 Mbps in LTE and WiMAX are shown in FIG. 18. High data rate requirements demand high SINR requirement as shown. And the RSSI per subcarrier requirement is affected by the interference per subcarrier from other cells significantly, shown by FIG. 19 and FIG. 20. When the interference per subcarrier decreases from −85 dBm to −120 dBm, the required RSSI per subcarrier also is lowered from −66 dBm to −75 dBm in the LTE system with 100 Mbps. In the WiMAX with the same peak data rate, the RSSI per subcarrier requirement decreases from −67.5 dBm to −76 dBm. For example of A-DANL in the LTE system with the peak data throughput of 50 Mbps and other systems settings given above, we can derive its RSSI per subcarrier requirement is −75 dBm by FIG. 19A. Therefore, the determined antenna numbers and locations for this LTE system are same as the solution shown in FIG. 11D, which can be also for the A-DANL in the WiMAX system with 55 Mbps if the interference per subcarrier from other cells is −85 dBm. Similarly, to achieve 99% coverage of LTE with 40 Mbps data rates and the interference per subcarrier is −120 dBm, the A-DANL results with the RSSI per subcarrier requirement of −85 dBm would be the solution in FIG. 11B.

In Section 7 and 8, the interference per subcarrier from other cells is the average interference for all receiver points. In practice, the measured interference from other cells always shows much difference at different receiver points. For this reason, the RSSI per subcarrier requirements could be considered individually when the path loss at each receiver point is analyzed in Eq. (3) and (4). Let's assume the RSSI per subcarrier requirements at all receiver points, {RSSI_{req}_{_{—}}_{perSubcarrier,i}}ᵢ₌₁^{I} are calculated by Eq. (13) and antenna EIRP is 0 dBm. If the minimum RSSI per subcarrier requirement among all receiver point is RSSI_{min Req}_{_{—}}_{perSubcarrier} for i=x, we have the interference margin set, {Δ}ᵢ₌₁^{I}={Δ₁, Δ₂, . . . , Δₓ, . . . Δ_{I}}, where Δᵢ=RSSI_{perSubcarrier,i}−RSSI_{min Req}_{_{—}}_{perSubcarrier} and Δₓ=0. Then, Γᵢ in the step of (2.2) would be rewritten to,

$${Γ}_{i}^{′} = \frac{{[ PL ( {r}_{i} ) + {Δ}_{i} ]}^{2}}{{\sum }_{{r}_{j} ∈ R} {[ PL ( {r}_{j} ) + {Δ}_{j} ]}^{2}} . \qquad ( 14 )$$

and Eq. (4) is updated to

$$\{ \begin{matrix}{c}_{k , x} = {r}_{1 , x} \cdot \frac{PL ( {r}_{1 , k} ) + {Δ}_{1 , k}}{{\sum }_{all {r}_{i} ∈ {cell}_{k}}^{{I}_{k}} [ PL ( {r}_{i , k} ) ++ {Δ}_{i , k} ]} + … + {r}_{{I}_{k} , x} \cdot \frac{PL ( {r}_{{I}_{k} , k} ) + {Δ}_{{I}_{k} , k}}{{\sum }_{all {r}_{i} ∈ {cell}_{k}}^{{I}_{k}} [ PL ( {r}_{i , k} ) ++ {Δ}_{i , k} ]} \\ {c}_{k , y} = {r}_{1 , y} \cdot \frac{PL ( {r}_{1 , k} ) + {Δ}_{1 , k}}{{\sum }_{all {r}_{i} ∈ {cell}_{k}}^{{I}_{k}} [ PL ( {r}_{i , k} ) ++ {Δ}_{i , k} ]} + … + {r}_{{I}_{k} , y} \cdot \frac{PL ( {r}_{{I}_{k} , k} ) + {Δ}_{{I}_{k} , k}}{{\sum }_{all {r}_{i} ∈ {cell}_{k}}^{{I}_{k}} [ PL ( {r}_{i , k} ) ++ {Δ}_{i , k} ]} .\end{matrix} \qquad ( 15 )$$

The PL(r) mentioned in Section 6 should be also replaced by PL(r)+Δ. Those receiver points with high interference will be compensated by the interference margin Δ.
9. Automatic Determination of Antenna Numbers and Locations with the Requirement of Network Sharing

Network sharing is not new in the wireless business to save the cost. With the growth in mobile users and traffic, costs of managing existing and rolling out new networks, and overlapping coverage by multiple operators, operators tend to share the infrastructure to increase operational efficiency and focus on new technologies or services. Therefore, if multiple operators share the antennas with different technologies/frequency bands in a coverage area, A-DANL considers the difference of the required antenna numbers due to the different technologies used by multiple operators.

To cover an area, the technology with higher frequency band, i.e., 1800 MHz, shows higher path loss referring to Eq. (1) and requires more antennas than that with lower frequency band, i.e., 900 MHz. Assuming operator A using the frequency band of 1800 MHz and operator B using 900 MHz frequency band, A-DANL should be processed for the operator using the technology with lower frequency band. The antenna number, N_{B}, is stored for operator B as its cost accounting. Then, another round A-DANL for the operator A using higher frequency band will be performed by the A-DANL method based on the antennas placed already, described in Section 4. As a result, the antennas with its number of N_{B} are shared by the two operators, and the additional antennas placed in the second A-DANL round would be afforded by operator A.

The criteria to share the antennas is that A-DANL method for the operator requiring less antennas is processed firstly and the results in the first A-DANL round will be considered as the pre-existing antennas in the second round of A-DANL for another operator. Accordingly, if operator A and B are using the same frequency bands, but different target RSSIs, this criteria also works because higher target RSSI results in more antennas required while lower RSSI requirement can be satisfied by less antennas. The number of A-DANL rounds is the number of operators using technologies with different frequency bands or different RSSI requirements.

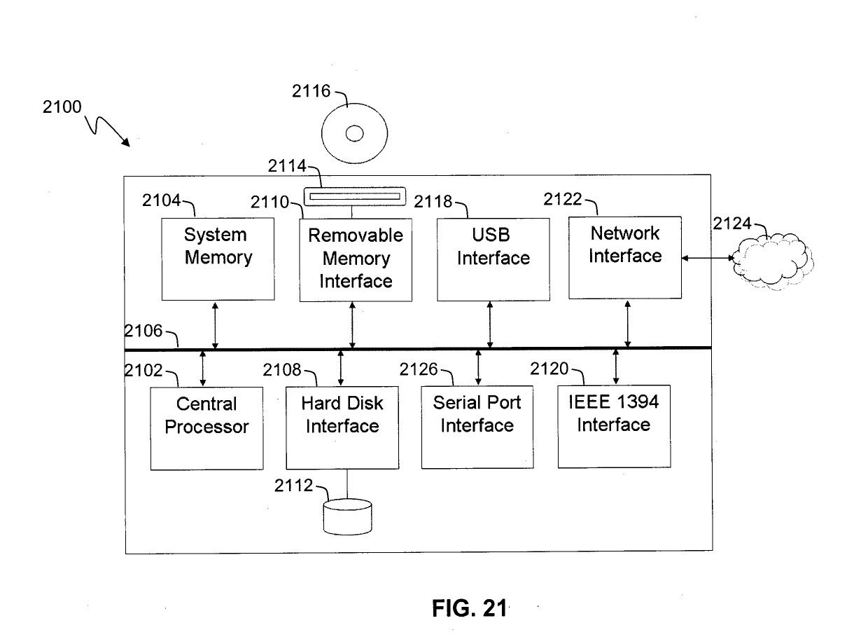

FIG. 21 illustrates a computer system 2100, with which the methods of the present invention may be implemented.

The computer system 2100 includes a central processor 2102, a system memory 2104 and a system bus 2106 that couples various system components including the system memory 2104 to the central processor 2102. The system bus 2106 may be any of several types of bus structures including a memory bus or memory controller, a peripheral bus, and a local bus using any of a variety of bus architectures. The structure of system memory 2104 is well known to those skilled in the art and may include a basic input/output system (BIOS) stored in a read only memory (ROM) and one or more program modules such as operating systems, application programs and program data stored in random access memory (RAM).

The computer system 2100 may also include a variety of interface units and drives for reading and writing data. In particular, the computer system 2100 includes a hard disk interface 2108 and a removable memory interface 2110 respectively coupling a hard disk drive 2112 and a removable memory drive 2114 to system bus 2106. Examples of removable memory drives 2114 include magnetic disk drives and optical disk drives. The drives and their associated computer-readable media, such as a Digital Versatile Disc (DVD) 2116 provide nonvolatile storage of computer readable instructions, data structures, program modules and other data for the computer system 2100. A single hard disk drive 2112 and a single removable memory drive 2114 are shown for illustration purposes only and with the understanding that the computer system 2100 may include several of such drives. Furthermore, the computer system 2100 may include drives for interfacing with other types of computer readable media.

The computer system 2100 may include additional interfaces for connecting devices to system bus 2106. FIG. 21 shows a universal serial bus (USB) interface 2118 which may be used to couple a device to the system bus 2106. An IEEE 1394 interface 2120 may be used to couple additional devices to the computer system 2100.

The computer system 2100 can operate in a networked environment using logical connections to one or more remote computers or other devices, such as a server, a router, a network personal computer, a peer device or other common network node, a wireless telephone or wireless personal digital assistant. The computer 2100 includes a network interface 2122 that couples system bus 2106 to a local area network (LAN) 2124. Networking environments are commonplace in offices, enterprise-wide computer networks and home computer systems.

A wide area network (WAN), such as the Internet, can also be accessed by the computer system 2100, for example via a modem unit connected to serial port interface 2126 or via the LAN 2124.

It will be appreciated that the network connections shown and described are exemplary and other ways of establishing a communications link between the computers can be used. The existence of any of various well-known protocols, such as TCP/IP, Frame Relay, Ethernet, FTP, HTTP and the like, is presumed, and the computer system 2100 can be operated in a client-server configuration to permit a user to retrieve web pages from a web-based server. Furthermore, any of various conventional web browsers can be used to display and manipulate data on web pages.

The operation of the computer system 2100 can be controlled by a variety of different program modules. Examples of program modules are routines, programs, objects, components, and data structures that perform particular tasks or implement particular abstract data types. The present invention may also be practiced with other computer system configurations, including hand-held devices, multiprocessor systems, microprocessor-based or programmable consumer electronics, network PC's, minicomputers, mainframe computers, personal digital assistants and the like. Furthermore, the invention may also be practiced in distributed computing environments where tasks are performed by remote processing devices that are linked through a communications network. In a distributed computing environment, program modules may be located in both local and remote memory storage devices.

In addition to operating the steps of the method above, the computer system 2100 advantageously generates a report specifying the antenna number and the antenna locations determined by the method. The report may then be output on a computer interface.

Similarly, the computer system 2100 includes a user interface module for receiving network related parameters such as a size of the communications network, a coverage area of an antenna, a minimum data rate, an orthogonality factor, an interference, a receiver noise power, a MIMO mode, a subcarrier number, a subframe/frame length and a symbol number per subframe/frame, an area or indoor floor plan, non-placement areas, receiver spacing, or any other suitable parameter.

Although the present invention has been described in terms of its preferred embodiments, those skilled in the art will recognize that the invention can be implemented with many modifications and variations within the scope of the appended claims.

1. A computer implemented method for communication network design, the method including:
generating, by a computer processor, a plurality of receiver points;
generating, by a computer processor, a target received signal strength for each receiver point of the plurality of receiver points;
determining, by a computer processor, a predicted number of antennas based on a size of the communications network and a coverage area of an antenna;
determining, by a computer processor, a location for each antenna of the predicted number of antennas;
comparing, by a computer processor, an estimated received signal strength for each receiver point of the plurality of receiver points with the target received signal strength for the receiver point;
generating a revised predicted number of antennas based upon at least one of the comparisons of target received signal strength and estimated received signal strength.

2. A method according to claim 1, wherein the communications network includes at least one of a Global System for Mobile Communications (GSM), Wideband Code Division Multiple Access (WCDMA), Code Division Multiple Access 2000 (CDMA2000), 3GPP Long Term Evolution (LTE), Wireless Fidelity (WiFi), and Worldwide Interoperability for Microwave Access (WiMAX) network component.

3. A method according to claim 2, wherein the target received signal strength is generated based upon at least one of a minimum data rate, an orthogonality factor, an interference, a receiver noise power, a MIMO mode, a subcarrier number, a subframe/frame length and a symbol number per subframe/frame.

4. A method according to claim 3, further including:
determining that at least one receiver point of the plurality of receiver points is covered by a pre-existing antenna;
removing the at least one receiver point from the plurality of receiver points.

5. A method according to claim 4, wherein the plurality of receiver points are generated based at least partly on an accuracy or time-limitation requirement.

6. A method according to claim 5, wherein the step of determining a location for each antenna of the predicted number of antennas includes:
determining an initial location for each antenna based at least partly on an antenna path loss between the antennas; and
updating, based upon at least a receiver path loss between at least one receiver point and the antennas, the location for each antenna.

7. A method according to claim 6, wherein the receiver path loss is determined based upon a path attenuation between the antenna and the receiver point, including at least one of a free space path loss, a buildings loss, a wall penetration loss, a log-normal fade margin and an interference margin.

8. A method according to claim 7, wherein the initial location for each antenna is determined using at least a random component.

9. A method according to claim 8, wherein the steps of determining a location for each antenna, generating an estimated received signal strength for each receiver point and comparing the estimated received signal strength for each receiver point with the target received signal strength for the receiver point are performed a plurality of times, wherein the determining a location for each antenna is performed using different initialisation parameters each of the plurality of times.

10. A method according to claim 9, wherein the step of updating the antenna locations includes:
identifying an obstacle within a specified distance to the antenna;
calculating a distance between the obstacle and the antenna; and
updating the antenna location based upon the distance between the obstacle and the antenna.

11. A method according to claim 10, wherein the step of updating the antenna locations includes:
identifying an antenna within a non-placement area; and
updating the antenna location based upon the non-placement area.

12. A method according to claim 11, wherein the receiver points are generated equally spaced across the network coverage area.

13. A method according to claim 12, wherein the spacing is 0.5 m, 1 m or 2 m.

14. A method according to claim 13, wherein the receiver points are grouped into a first group and a second group, wherein the first and second groups having at least one of a differing target received signal strength, and a differing target coverage.

15. A method according to claim 14, wherein the predicted number of antennas is increased until a target received signal strength and coverage requirement is met.

16. A method according to claim 15,
further including generating a report, on a computer processor, and outputting the report on a computer interface, the report specifying at least an antenna number and antenna locations.

17. A system for communication network design including:
a user interface module for receiving network related parameters;
a receiver point generation module, for generating a plurality of receiver points based upon at least one of the network related parameters;
a target strength generation module, for generating a target received signal strength for each receiver point of the plurality of receiver points;
an antenna prediction module, for generating a predicted number of antennas based the network related parameters;
an antenna location module, for determining a location for each antenna of the predicted number of antennas;
a signal strength estimation module, for generating an estimated received signal strength for each receiver point of the plurality of receiver points, based upon the predicted number of antennas and the location of each antenna of the predicted number of antennas;
a signal strength comparison module, for comparing the estimated received signal strength for each receiver point with the target received signal strength for the receiver point;
a control module, for controlling the an antenna prediction module, the antenna location module, the signal strength estimation module, and the signal strength comparison module such that the antenna numbers and locations are revised, and signal strengths are determined and compared until a predetermined criteria are met.

18. A non-transitory computer readable medium having stored thereon computer executable instructions for performing the method of claims 1.

19. A method according to claim 4, wherein the network is shared by a first operator and a second operator, further including:
determining, on a computer processor, that the first operator requires fewer antennas than the second operator;
wherein the steps of:
generating a target received signal strength for each receiver point of the plurality of receiver points, determining a predicted number of antennas based on a size of the communications network and a coverage area of an antenna,
determining a location for each antenna of the predicted number of antennas,
generating an estimated received signal strength for each receiver point of the plurality of receiver points, based upon the predicted number of antennas and the location of each antenna of the predicted number of antennas,
comparing, by a computer processor, the estimated received signal strength for each receiver point with the target received signal strength for the receiver point and
generating a revised predicted number of antennas based upon at least one of the comparisons of target received signal strength and estimated received signal strength
are performed initially for the first operator, and subsequently for the second operator; and
the revised predicted number of antennas of the first operator are pre-existing antennas to the second operator.

20. A method according to claim 19, wherein the step of determining that the first operator requires fewer antennas than the second operator includes at least one of determining that the first operator uses technology with a lower frequency band than the second operator, and that the first operator has a lower target received signal strength for each receiver point.

21. A method according to claim 20, wherein the antenna numbers and locations are determined with coexistence of multi-service coverage areas.
